(19) United States
(12) Patent Application Publication
(10) Pub. No.: US 2021/0299620 A1
(43) Pub. Date: Sep. 30, 2021

(54) PROGRESSIVE-PERFORATION-TYPE CRUSHING AND REFINING STRUCTURE

(71) Applicant: JODEN INC.

(72) Inventor: Zhengfeng XU, Jiangmen City (CN)

(21) Appl. No.: 17/260,399

(22) PCT Filed: Mar. 15, 2019
(86) PCT No.: PCT/CN2019/078201

§ 371 Date: Jan. 14, 2021

(30) Foreign Application Priority Data
Aug. 15, 2018 (CN) 201810926366.X

(51) Int. Cl. B01F 5/06; B01F 3/04; B01F 5/00; B01F 5/04

(52) U.S. Cl. CPC B01F 5/0693; B01F 3/04503; B01F 2003/04858; B01F 5/0415; B01F 5/0426; B01F 5/0065

(57) ABSTRACT

A progressive-perforation-type crushing and refining structure is disclosed, which includes a thin-wall-shaped primary crushing and refining member and a secondary crushing and refining member, the primary crushing and refining member and the secondary crushing and refining member are both provided with a plurality of micro-pore channels used for crushing and refining bubbles in a fluid, the primary crushing and refining member and the secondary crushing and refining member cooperate to form a buffer space, and at least one quarter of the plurality of micro-pore channels of the primary crushing and refining member and the secondary crushing and refining member are arranged in an overlapped or superposed manner in a flow direction of the fluid.

### CROSS-REFERENCE TO RELATED APPLICATIONS

This application claims priority to Chinese patent application No. 201810926366X, filed Aug. 15, 2018, the content of which is incorporated herein by reference in its entirety.

### TECHNICAL FIELD

The present disclosure relates to a bubble refining structure, and more particularly, to a progressive-perforation-type crushing and refining structure.

### BACKGROUND

In the existing technology, in the fields of aquaculture, wastewater treatment, chemical reaction, medical and health care, plant cultivation, industrial cleaning and descaling, and the like, it is often necessary to mix air into a water medium to obtain a bubble-contained water working medium, which is intended to increase a contact area between the air and the water to improve various treatment effects. Most obviously, cleaning and descaling abilities are improved.

In recent years, the bubble-contained water working medium is also applied to the field of daily life, which may be used for soaking or washing vegetables, fruits and dishes, and may also be used for bathing and rinsing.

In order to make the water contain bubbles, the air may be pressed in by external power, such as a compressor and an air pump. The air may also be sucked in by using a negative pressure generated by flow of the water, such as a bubble acquisition apparatus with a Venturi tube structure or a vortex structure.

The bubble acquisition apparatus with the Venturi tube structure mainly utilizes a principle of an increased water flow speed and a decreased water pressure. The bubble acquisition apparatus with the Venturi tube structure is provided with a tapered pipeline to increase the water flow speed and form a vacuum zone lower than an external atmosphere at a throat of the pipeline, and external air is sucked into the pipeline by means of the vacuum zone.

The bubble acquisition apparatus with the vortex structure mainly utilizes a principle of a low central pressure of a centrifugal movement. The bubble acquisition apparatus with the vortex structure makes a water flow rotate and generate a centrifugal action, and then a vacuum zone lower than an external atmosphere is formed at a rotating center. The vacuum zone sucks the external air into the pipeline.

The Venturi tube structure specifically refers to China's Taiwan patent TW20170212400U titled micro-bubble generator, and the vortex structure specifically refers to China patents CN102958589B titled micro-bubble generating apparatus and CN203916477U titled micro-bubble generating apparatus. The micro-bubble generator and the micro-bubble generating apparatus may collectively refer to a micro-bubble acquisition apparatus.

The micro-bubble acquisition apparatus may make water contain micro-bubbles with a diameter lower than tens of microns or even several microns, thus prolonging retention time of the bubbles in the water, and increasing a ratio of a surface area to a volume of the bubbles at the same time, so that the bubbles have a higher adsorption characteristic. Therefore, the cleaning and descaling abilities are improved.

Compared with the Venturi tube structure, the vortex structure has the advantage of reducing a length of the bubble acquisition apparatus, and is insensitive to a change of a water flow rate. Therefore, the vortex structure is usually used in an existing micro-bubble acquisition apparatus.

However, in the existing design, a high-mesh-number filter or a conical mesh with a plurality of cut holes is generally used in the micro-bubble acquisition apparatus to generate micro-bubbles, but the former is easy to be blocked, and the bubbles generated by the latter are difficult to reach a micro-nano level.

### SUMMARY

The present disclosure aims to solve the above-mentioned technical problems, and provides a progressive-perforation-type crushing and refining structure, which is not easy to be blocked, and may make a micro-bubble acquisition apparatus generate a large number of micro-nano bubbles stably.

The present disclosure is realized by the following technical solutions.

A progressive-perforation-type crushing and refining structure, which includes a thin-wall-shaped primary crushing and refining member and a secondary crushing and refining member, the primary crushing and refining member and the secondary crushing and refining member being both provided with a plurality of micro-pore channels used for crushing and refining bubbles in a fluid, the primary crushing and refining member and the secondary crushing and refining member are configured to cooperate to form a buffer space, and at least one quarter of the plurality of micro-pore channels of the primary crushing and refining member and the secondary crushing and refining member are arranged in an overlapped or superposed manner in a flow direction of the fluid.

In some embodiments, an equivalent diameter of the micro-pore channels is 0.2 mm to 0.8 mm.

In some embodiments, the primary crushing and refining member is arranged as a cone, and a tip of the cone is arranged in a direction away from the secondary crushing and refining member.

In some embodiments, the secondary crushing and refining member is arranged as a cone, and a tip of the cone is arranged in a direction away from the primary crushing and refining member.

In some embodiments, the primary crushing and refining member or the secondary crushing and refining member is arranged as a pyramid.

In some embodiments, a first ring for accommodating the primary crushing and refining member is formed at an outer edge of the primary crushing and refining member.

In some embodiments, a positioning edge is provided at an outer edge of the secondary crushing and refining member.

In some embodiments, the progressive-perforation-type crushing and refining structure further comprises a final crushing and refining member, and a transition space is formed between the final crushing and refining member and the secondary crushing and refining member.

In some embodiments, the primary crushing and refining member and the final crushing and refining member are connected to clamp and fix the secondary crushing and refining member.

Compared with the existing technology, the progressive-perforation-type crushing and refining structure of the present disclosure is provided with the thin-wall-shaped primary crushing and refining member to replace a high-mesh-number filter screen, on one hand, a number of holes is reduced, particles may be deposited, and blockage is delayed, thus prolonging maintenance-free time of a micro-bubble acquisition apparatus; and on the other hand, under throttling and beaming actions of the micro-pore channels, a water flow shows a jet turbulent flow after passing through the micro-pore channels, with collision, disturbance and oscillation excitation, which may crush large bubbles to obtain finer bubbles, and then, the bubbles are further refined to a micro-nano level by arranging the secondary crushing and refining member to meet a demand. In addition, the buffer space is formed between the primary crushing and refining member and the secondary crushing and refining member, so that the bubbles may repeatedly collide, disturb and vibrate after passing through the primary crushing and refining member; and in addition, at least one quarter of the micro-pore channels of the primary crushing and refining member and the secondary crushing and refining member are overlapped or superposed along the flow direction of the fluid, so that the bubbles are able to smoothly flow to the micro-pore channels of the secondary crushing and refining member through the micro-pore channels of the primary crushing and refining member, thereby reducing a flow resistance of the water flow, avoiding a larger back pressure resistance at the progressive-perforation-type crushing and refining structure, without affecting an air input of the micro-bubble acquisition apparatus.

### BRIEF DESCRIPTION OF THE DRAWINGS

In order to explain the technical solutions in the embodiments of the present disclosure more clearly, the accompanying drawings needing to be used in description of the embodiments are briefly described hereinafter.

Apparently, the described accompanying drawings are only some but not all of the embodiments of the present disclosure, and those skilled in the art may also obtain other design schemes and accompanying drawings according to these accompanying drawings without going through any creative work.

FIG. 1 is a schematic sectional view of a micro-bubble acquisition apparatus of the present disclosure;

FIG. 2 is a schematic cross-sectional view of a vortex cavity of the micro-bubble acquisition apparatus in FIG. 1;

FIG. 3 is a schematic structure diagram of another embodiment of the micro-bubble acquisition apparatus in FIG. 1;

FIG. 4 is a schematic exploded view of the micro-bubble acquisition apparatus in FIG. 1; and

FIG. 5 is a schematic diagram of another embodiment of a progressive-perforation-type crushing and refining structure in the micro-bubble acquisition apparatus.

Numerals of technical features: 1 refers to first body, 2 refers to water inlet channel, 3 refers to vortex cavity, 4 refers to primary crushing and refining member, 5 refers to secondary crushing and refining member, 6 refers to micro-pore channel, 7 refers to front space, 8 refers to buffer space, 9 refers to final crushing and refining member, 10 refers to transition space, 11 refers to air inlet channel, 12 refers to water inlet, 12a refers to water inlet pore, 12b refers to auxiliary air inlet pore, 13 refers to water outlet pore, 14 refers to beaming part, 3a refers to first bottom wall, 3b refers to first side wall, 41 refers to first ring, and 51 refers to positioning edge.

### DETAILED DESCRIPTION

The concept, the specific structure and the generated technical effect of the present disclosure are clearly and completely described hereinafter with reference to the embodiments and the accompanying drawings to fully understand the objectives, the features and the effects of the present disclosure.

Apparently, the described embodiments are only some but not all of the embodiments of the present disclosure, and based on the embodiments of the present disclosure, other embodiments obtained by those skilled in the art without going through any creative work all belong to the scope of protection of the present disclosure.

In addition, all connection relationships mentioned therein do not indicate direct connection between members only, but indicate that a better connection structure may be formed by adding or reducing a connection accessory according to specific implementation conditions. The various technical features in the present disclosure may be combined interactively on the premise of not conflicting with each other.

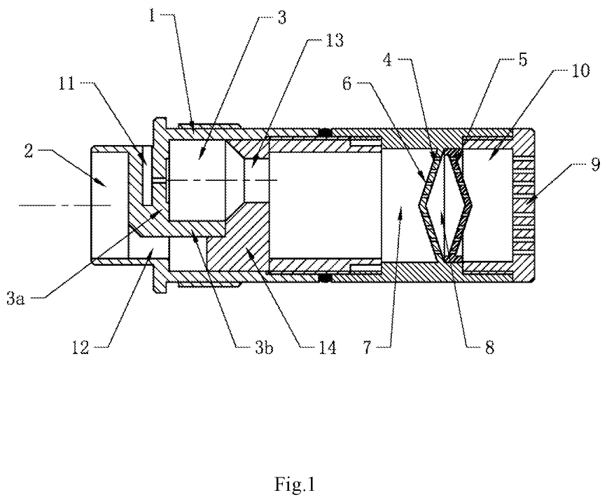

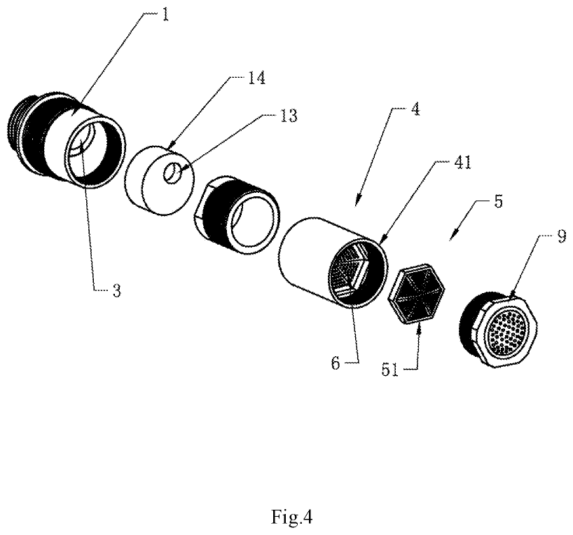

As shown in FIG. 1 and FIG. 4, a micro-bubble acquisition apparatus comprises a first body 1. The first body 1 is provided with a water inlet channel 2, a water outlet channel, a vortex cavity 3 communicating the water inlet channel 2 with the water outlet channel, and an air inlet channel 11 communicated with the vortex cavity 3. The water outlet channel is provided with a structure for generating micro-bubbles. Center lines in FIG. 1 are respectively an axis of the water inlet channel 2 and an axis of the vortex cavity 3.

The air inlet channel 11 may be connected with a compressor, an air pump, and the like, and then, air is pressed into the vortex cavity 3 by using external power. Certainly, the air may also be sucked into the air inlet channel 11 by utilizing a negative pressure generated by flow of water.

For the vortex cavity 3, the first body 1 is provided with a first side wall 3b and a first bottom wall 3a for forming the vortex cavity 3. The first side wall 3b is provided with a water inlet hole 12a communicated with the vortex cavity 3, and an orientation of the water inlet hole 12a deviates from a center of the vortex cavity 3, so that a water flow generates vortex flow after passing through the water inlet hole 12a.

The water inlet channel 2 is usually arranged on a first bottom wall 3a, and the air inlet channel 11 comprises a first air channel arranged along an axial direction of the vortex cavity 3 and a second air channel arranged perpendicular to the axial direction of the vortex cavity 3. The first air channel is communicated with the second air channel, the first air channel is communicated with the outside, and the second air channel is communicated with the vortex cavity 3, thus being convenient for manufacturing, without affecting installation and use of the micro-bubble acquisition apparatus.

For the first body 1, one end of the first body 1 close to the water inlet channel 2 may be provided with or integrally formed with a connector, so that the micro-bubble acquisition apparatus may be fixed on a faucet.

Certainly, the first body 1 may also be installed in a water pipe, and the first body 1 and the water pipe are sealed through a sealing ring, so that the water flows into the water inlet channel 2, and then flows out through the vortex cavity 3 and the water outlet channel. At the moment, the water inlet channel 2 may be a water channel portion of the water pipe close to the first body 1, and the water inlet channel 2 may be omitted from the first body 1.

Conventionally, the axis of the vortex cavity 3 coincides with the axis of the water inlet channel 2, which is referred to as a forward vortex cavity 3 or a forward vortex structure hereinafter, resulting in a narrow annular water inlet 12 of the micro-bubble acquisition apparatus, so that flow of the water is hindered and air is difficult to be sucked in. Moreover, increase of a size of the annular water inlet 12 also increases a diameter of the micro-bubble acquisition apparatus, thus being difficult to adapt to a conventional water pipe specification.

Certainly, discussions on advantages and disadvantages of forward and offset vortex structures herein do not affect combination of the forward or offset vortex structure with the following progressive-perforation-type crushing and refining structure, that is to say, the forward or offset vortex structure is able to be combined with the following progressive-perforation-type crushing and refining structure to form the micro-bubble acquisition apparatus.

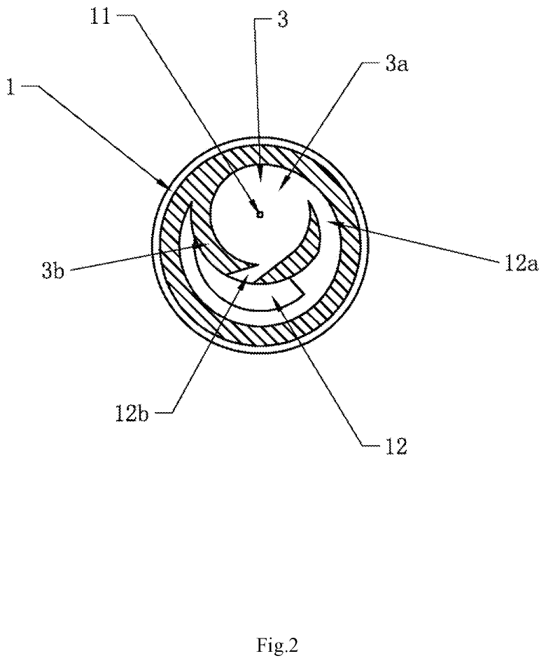

In order to address the problems caused by the forward vortex cavity 3, as shown in FIG. 1 and FIG. 2, the axis of the vortex cavity 3 may be offset from the axis of the water inlet channel 2, the vortex cavity 3 is provided with a water inlet 12 communicated with the water inlet channel 2, and the water inlet 12 is arranged on one side of the axis of the water inlet channel 2 away from the axis of vortex cavity 3, which means that, the offset vortex structure is used.

In the micro-bubble acquisition apparatus in the embodiment, the water inlet 12 is arranged on one side of the axis of the water inlet channel 2 away from the axis of the vortex cavity 3 by making the axis of the vortex cavity 3 offset from the axis of the water inlet channel 2, so that the water inlet channel 12 communicated with the vortex cavity 3 is changed from a narrow ring shape to a crescent shape or a column shape, so as to avoid the water flow from passing through a narrow gap, thus increasing a radial size of the water flow, reducing a water flow resistance, and facilitating the water flow to flow into the vortex cavity 3. Therefore, the diameter of the micro-bubble acquisition apparatus is not increased, or is even reduced. Therefore, the micro-bubble acquisition apparatus can be miniaturized, and is conveniently connected with the water pipe or arranged inside the water pipe, thereby having a good universality.

In order to further explain the beneficial effects generated in the embodiment, detailed description is now made.

Currently, the mainstream pipe diameters of a domestic water pipeline mainly comprise an outer diameter of 28 mm and an outer diameter of 22 mm, and taking the pipeline with the outer diameter 28 mm as an example, if a bubble generating apparatus is made as a built-in type, an outer diameter thereof must not exceed 24.5 mm. That is to say, the water inlet 12 can only be arranged in an annular area with a width not exceeding 2.5 mm, which makes an area of the water inlet 12 smaller. Alternatively, compared with a conventional round-hole water inlet 12, an outer contour length of the water inlet 12 is increased, so that flow of the water flow is hindered. Therefore, a back pressure is greatly increased, which affects a suction effect of a vortex, and even a pipeline flow rate is significantly lowered.

Therefore, an existing structure of the forward vortex cavity 3 is difficult to be built in the pipeline with the diameter of 28 mm.

In sharp contrast to the existing design, the offset vortex cavity 3 is used in the present disclosure. Due to offset of the vortex cavity 3, the axis of the vortex cavity 3 is offset from the axis of the water inlet channel 2 by a distance, and the distance allows the water inlet 12 to be arranged in a crescent-shaped area, with a radius difference of 3 mm to 4 mm. The water inlet 12 may be close to an ellipse or a circle from a narrow strip, so that the outer contour length of the water inlet 12 is reduced, thus facilitating the water flow to pass through the water inlet 12, without increasing an outer diameter of the first body 1. In other words, the offset vortex cavity 3 can reduce a volume and an occupied space of the micro-bubble acquisition apparatus, thereby being convenient to be built in the domestic water pipe.

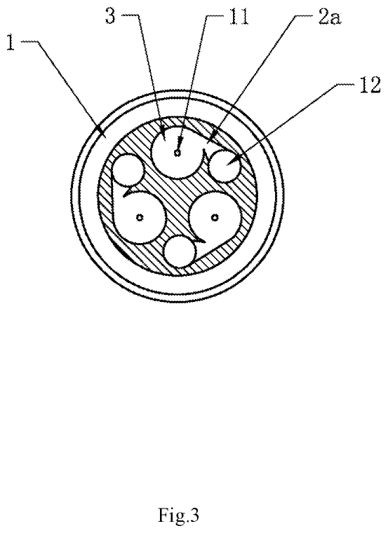

As shown in FIG. 3, as an alternative to the micro-bubble acquisition apparatus in FIG. 1, several vortex cavities 3 may be provided, and a number of the water inlets 12 is arranged corresponding to a number of vortex cavities 3. That is to say, a plurality of round-hole water inlets 12 are formed by changing a large vortex cavity 3 into a plurality of small vortex cavities 3, and a narrow condition of the water inlet 12 may be changed similarly.

As further development of the micro-bubble acquisition apparatus, the first body 1 is provided with a beaming part 14 covering the vortex cavity 3, and the beaming part 14 is provided with a water outlet hole 13 communicating the vortex cavity 3 with the water outlet channel. A cross-sectional area of the water outlet hole 13 is reduced along the direction of the water flow, so that the air and the water may be fully mixed to generate the bubbles. In addition, a change of the cross-sectional area of the water outlet hole 13 may also accelerate the water flow, compress the bubbles, and promote bubble crushing.

In order to simplify manufacturing, an outer contour of the beaming part 14 may be matched with the water outlet channel, which means that the beaming part 14 is manufactured separately, without increasing a manufacturing difficulty of the vortex cavity.

Certainly, the beaming part 14 may also be integrally manufactured with a first side wall 3b, but improvement needs to be made on the manufacturing. The first bottom wall 3a and the first side wall 3b need to be manufactured separately.

In order to make the water generate the vortex flow smoothly, the orientation of the water inlet hole 12a may be arranged along a tangential direction of the vortex cavity 3.

In order to avoid an aperture of the water inlet hole 12a being limited so as to reduce the water flow rate, two water inlet holes 12a may be provided, which means that, an auxiliary water inlet hole 12b is provided, so that a total area of the water inlet hole 12a is not decreased or increased.

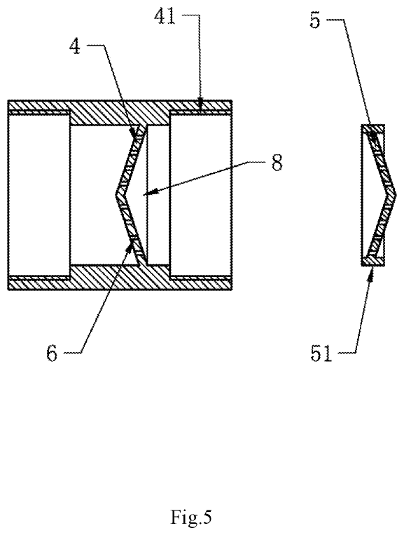

In order to address the problems of easy blockage of a filter screen and insufficient level of micro-bubbles generated by a conical mesh in the existing technology, as shown in FIG. 1, FIG. 4, and FIG. 5, a progressive-perforation-type crushing and refining structure is also used in the micro-bubble acquisition apparatus. Certainly, the progressive-perforation-type crushing and refining structure is not only suitable for the micro-bubble acquisition apparatus with the forward vortex structure, but also suitable for the micro-bubble acquisition apparatus with the offset vortex structure.

Specifically, the progressive-perforation-type crushing and refining structure comprises a thin-wall-shaped primary crushing and refining member 4 and a secondary crushing and refining member 5. The primary crushing and refining member 4 and the secondary crushing and refining member 5 are both provided with a plurality of micro-pore channels 6 used for crushing and refining bubbles in a fluid, where the primary crushing and refining member 4 and the secondary crushing and refining member 5 cooperate to form a buffer space 8, and at least one quarter of the micro-pore channels 6 of the primary crushing and refining member 4 and the secondary crushing and refining member 5 are arranged in an overlapped or superposed manner in a flow direction of the fluid. According to the above micro-bubble acquisition apparatus, the flow direction of the fluid is an axial direction of a channel where the fluid is located.

The progressive-perforation-type crushing and refining structure in the embodiment is provided with the thin-wall-shaped primary crushing and refining member 4 to replace a high-mesh-number filter screen. On one hand, a number of holes is reduced, particles may be deposited, and blockage is delayed, thus prolonging maintenance-free time of a micro-bubble acquisition apparatus. On the other hand, under throttling and beaming actions of the micro-pore channels 6, a water flow shows a jet turbulent flow after passing through the micro-pore channels 6, with collision, disturbance and oscillation excitation, which may crush large bubbles to obtain finer bubbles, and then, the bubbles are further refined to a micro-nano level by arranging the secondary crushing and refining member 5 to meet a demand. In addition, the buffer space 8 is formed between the primary crushing and refining member 4 and the secondary crushing and refining member 5, so that the bubbles may repeatedly collide, disturb and vibrate after passing through the primary crushing and refining member. In addition, at least one quarter of the micro-pore channels 6 of the primary crushing and refining member 4 and the secondary crushing and refining member 5 are overlapped or superposed along the flow direction of the fluid, so that the bubbles are able to smoothly flow to the micro-pore channels 6 of the secondary crushing and refining member 5 through the micro-pore channels 6 of the primary crushing and refining member 4, thus reducing a flow resistance of the water flow, avoiding a larger back pressure resistance at the progressive-perforation-type crushing and refining structure, without affecting an air input of the micro-bubble acquisition apparatus.

Specifically, a mode of arranging the primary crushing and refining member 4 and the secondary crushing and refining member 5 is used in the progressive-perforation-type crushing and refining structure, and the micro-pore channels 6 arranged are used as outflow channels of a fluid working medium, thus forming a crushing and refining structure with a characteristic of two-stage progressive perforation.

The micro-pore channels 6 on the primary crushing and refining member 4 are first-stage perforations and second-stage perforations are formed by the micro-pore channels 6 of the secondary crushing and refining member 5. When the fluid working medium mixed with the bubbles passes through the first-stage perforations, flow thereof is characterized by jet flow due to a throttling effect and a beaming action of the micro-pore channels 6. At the moment, a flow speed of the fluid is accelerated, and with a characteristic of turbulent flow.

Under excitations of collision, disturbance and oscillation of the turbulent flow, large bubbles are broken, so as to obtain finer bubble water, and then finer bubbles are further crushed and refined by the second-stage perforations, so as to become micro-bubbles finally.

Certainly, in order to make the micro-bubble acquisition apparatus suitable for being installed at a tail end of a faucet, a final crushing and refining member 9 may also be provided, which may make the water flow out stably in addition to further refining the bubbles, without affecting a water outlet effect.

In order to improve a bubble crushing ability of the micro-pore channels 6, a diameter of the micro-pore channels 6 or/and an equivalent diameter of the micro-pore channels may be 0.2 mm to 0.8 mm, otherwise the generated bubbles are too large or the water flow rate is insufficient. The equivalent diameter may be calculated through S=πd²/4, where S is a cross-sectional area of the micro-pore channels 6. That is to say, the micro-pore channels 6 may have a non-circular structure, such as a triangle, an ellipse, a polygon, and other various abnormities.

In order to enhance a strength of the primary crushing and refining member 4, and enable the water flow to flow along a surface of the primary crushing and refining member 4 at the same time, thus crushing the bubbles through the micro-pore channel 6s in a cutting manner, the primary crushing and refining member 4 may be arranged as a cone, and a tip of the cone is arranged in a direction away from the secondary crushing and refining member 5.

In order to form the buffer space 8 without increasing a number of parts and a length of the micro-bubble acquisition apparatus, the secondary crushing and refining member 5 can be arranged as a cone, and a tip of the cone is arranged in a direction away from the primary crushing and refining member 4.

In order to make the water flow parallel to a surface of the primary crushing and refining member 4 or the secondary crushing and refining member 5, the primary crushing and refining member 4 or the secondary crushing and refining member 5 may be arranged as a pyramid. Meanwhile, the primary crushing and refining member 4 or the secondary crushing and refining member 5 is arranged as the pyramid, which also facilitates the micro-pore channels 6 of the primary crushing and refining member and the secondary crushing and refining member to be superposed or overlapped.

In order to ensure that relative positions of the micro-pore channels 6 on the primary crushing and refining member 4 and the secondary crushing and refining member 5 meet requirements, a first ring 41 for accommodating the primary crushing and refining member 4 may be formed at an outer edge of the primary crushing and refining member 4.

In order to avoid deflection of the secondary crushing and refining member 5 in the first ring 41, which is to accurately install the secondary crushing and refining member 5 in the first ring 41, an outer edge of the secondary crushing and refining member 5 may be provided with a positioning edge 51.

For the final crushing and refining member 9, and a transition space 10 is formed between the final crushing and refining member 9 and the secondary crushing and refining member 5, so as to make the water flow stable.

In order to further reduce costs and the number of the parts, the primary crushing and refining member 4 and the final crushing and refining member 9 are connected to clamp and fix the secondary crushing and refining member 5.

The above embodiments are not limited to the self-provided technical solutions of the embodiments, and the embodiments may be combined with each other to form new embodiments. The above embodiments are only used to illustrate the technical solutions of the present disclosure, but are not intended to limit the present disclosure. Any modification or equivalent substitution made without deviating from the spirit and scope of the present disclosure shall all fall within the scope of the technical solutions of the present disclosure.

1. A progressive-perforation-type crushing and refining structure, comprising a thin-wall-shaped primary crushing and refining member and a secondary crushing and refining member, the primary crushing and refining member and the secondary crushing and refining member being both provided with a plurality of micro-pore channels used for crushing and refining bubbles in a fluid, wherein the primary crushing and refining member and the secondary crushing and refining member are configured to cooperate to form a buffer space-, and at least one quarter of the plurality of micro-pore channels of the primary crushing and refining member and the secondary crushing and refining member are arranged in an overlapped or superposed manner in a flow direction of the fluid.

2. The progressive-perforation-type crushing and refining structure of claim 1, wherein an equivalent diameter of the micro-pore channel is 0.2 mm to 0.8 mm.

3. The progressive-perforation-type crushing and refining structure of claim 1, wherein the primary crushing and refining member is arranged as a cone, and a tip of the cone is arranged in a direction away from the secondary crushing and refining member.

4. The progressive-perforation-type crushing and refining structure of claim 1, wherein the secondary crushing and refining member is arranged as a cone, and a tip of the cone is arranged in a direction away from the primary crushing and refining member.

5. The progressive-perforation-type crushing and refining structure of claim 1, wherein the primary crushing and refining member or the secondary crushing and refining member is arranged as a pyramid.

6. The progressive-perforation-type crushing and refining structure of claim 1, wherein a first ring for accommodating the primary crushing and refining member is formed at an outer edge of the primary crushing and refining member.

7. The progressive-performance-type crushing and refining structure of claim 2, wherein a first ring for accommodating the primary crushing and refining member is formed at an outer edge of the primary crushing and refining member.

8. The progressive-perforation-type crushing and refining structure of claim 3, wherein a first ring for accommodating the primary crushing and refining member is formed at an outer edge of the primary crushing and refining member.

9. The progressive-perforation-type crushing and refining structure of claim 4, wherein a first ring for accommodating the primary crushing and refining member is formed at an outer edge of the primary crushing and refining member.

10. The progressive-perforation-type crushing and refining structure of claim 5, wherein a first ring for accommodating the primary crushing and refining member is formed at an outer edge of the primary crushing and refining member.

11. The progressive-perforation-type crushing and refining structure of claim 6, wherein a positioning edge is provided at an outer edge of the secondary crushing and refining member.

12. The progressive-perforation-type crushing and refining structure of claim 1, further comprising a final crushing and refining member, and wherein a transition space is formed between the final crushing and refining member and the secondary crushing and refining member.

13. The progressive-perforation-type crushing and refining structure of claim 2, further comprising a final crushing and refining member, and wherein a transition space is formed between the final crushing and refining member and the secondary crushing and refining member.

14. The progressive-perforation-type crushing and refining structure of claim 3, further comprising a final crushing and refining member, and wherein a transition space is formed between the final crushing and refining member and the secondary crushing and refining member.

15. The progressive-perforation-type crushing and refining structure of claim 4, further composing a final crushing and refining member, and wherein a transition space is formed between the final crushing and refining member and the secondary crushing and refining member.

16. The progressive-perforation-type crushing and refining structure or claim 5, further comprising a final crushing and refining member, and wherein a transition space is formed between the final crushing and refining member and the secondary crushing and refining member.

17. The progressive-perforation-type crushing and refining structure of claim 12, wherein the primary crushing and refining member and the final crushing and refining member are connected to clamp and fix the secondary crushing and refining member.
